(19) United States
(12) Patent Application Publication
(10) Pub. No.: US 2014/0251129 A1
(43) Pub. Date: Sep. 11, 2014

(54) AUTOMATIC COALESCER REPLACEMENT SYSTEM AND METHOD

(71) Applicant: BHA Altair, LLC, Franklin, TN (US)

(72) Inventors: Siddharth Girishkumar Upadhyay, Bangalore (IN); Rajesh PS, Bangalore (IN); Bhalchandra Arun Desai, Smyma, GA (US)

(73) Assignee: BHA Altair, LLC, Franklin, TN (US)

(21) Appl. No.: 13/792,278

(22) Filed: Mar. 11, 2013

(51) Int. Cl. B01D 46/42; B01D 46/00

(52) U.S. Cl. CPC B01D 46/4227; B01D 46/002
USPC 95/19; 55/418; 96/400; 55/422; 96/397

(57) ABSTRACT

An inlet air treatment system and method comprises a used coalescer having intake air passing therethrough and an unused coalescer not having intake air passing therethrough. A mechanism automatically adjusts the inlet air treatment system such that the used coalescer is no longer in the airflow and the unused coalescer is in the airflow.

### BACKGROUND OF THE INVENTION

The present invention relates generally to inlet air treatment systems, and more specifically to systems and methods for replacing moisture coalescers for gas turbines.

Gas turbines include inlet air treatment systems that remove moisture and dust from air that is channeled to the compressor. Some inlet air treatment systems include moisture separators and coalescing pads that remove moisture from intake air, and final filters that remove dust and debris from the intake air. During normal operating conditions, it is desired to have the inlet air treatment system channel the dry, filtered air to the compressor with minimal airflow disruption and air pressure drop. Eventually, used coalescers become clogged and cause a higher air pressure drop under normal operating conditions. Over time, the pressure drop across the coalescers results in reducing the operating efficiency of the gas turbine. In some instances, the reduced air pressure may cause a compressor surge that may damage the compressor. Coalescers typically have to be removed manually to be cleaned or replaced. This removal process may require shutdown of the gas turbine.

Accordingly, it is desirable to provide a system and method for automatically replacing the coalescers during periods when the pressure drop through the coalescers exceeds a preset threshold in order to maintain compressor operating efficiency and to avoid a reduced air pressure that may cause a compressor surge. Moreover, it is desirable to provide a system that does not require the coalescers to be bypassed or replaced manually during operation of the gas turbine, which would require shutdown.

The discussion above is merely provided for general background information and is not intended to be used as an aid in determining the scope of the claimed subject matter.

### BRIEF DESCRIPTION OF THE INVENTION

An inlet air treatment system and method comprises a used coalescer having intake air passing therethrough and an unused coalescer not having intake air passing therethrough. A mechanism automatically adjusts the inlet air treatment system such that the used coalescer is no longer in the path of the airflow and the unused coalescer is in the path of the airflow. An advantage that may be realized in the practice of some disclosed embodiments of the inlet air treatment system is that the automatic replacement mechanism obviates the need for manual intervention, thereby reducing maintenance costs and system downtime.

In one embodiment, an inlet air treatment system has a first coalescer with an airflow passing therethrough. A second coalescer is blocked by a plate from having the airflow passing through it. A motorized mechanism is attached to the plate for moving the plate and thereby unblocking the second coalescer and causing the airflow to pass through it.

In another embodiment, an inlet air treatment system has a first coalescer with intake air passing therethrough. A second coalescer is blocked from having the intake air passing through it. A lifting mechanism is attached to facing edges of the first and the second coalescers to lift the edges such that the first coalescer is moved away from the intake air pathway while the second coalescer is moved into the intake air pathway.

In another embodiment, an inlet air treatment system has a first coalescer positioned in an intake air pathway with intake air passing therethrough while a second coalescer is positioned away from the intake air pathway. The first coalescer is attached to a mechanism for moving it out of the air intake pathway and the second coalescer is attached to a mechanism for moving it into the air intake pathway.

In another embodiment, a method comprises electronically monitoring a differential pressure across a first coalescer having an airflow passing therethrough, and detecting that the differential pressure exceeds a preset threshold. A second coalescer is introduced into the airflow in response to the detecting.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic view of an exemplary inlet air treatment system;

FIG. 2 is a schematic view of an exemplary filter replacement assembly that may be used with the inlet air treatment system shown in FIG. 1;

FIG. 3 is a schematic view of the exemplary filter replacement assembly of FIG. 2 in a replacement position;

FIG. 4 is a schematic view of an exemplary alternative filter replacement assembly that may be used with the inlet air treatment system shown in FIG. 1;

FIG. 5 is a schematic view of the exemplary filter replacement assembly of FIG. 4 in a replacement position;

FIG. 6 is a schematic view of a further exemplary alternative filter replacement assembly that may be used with the inlet air treatment system shown in FIG. 1;

FIG. 7 is a schematic view of the exemplary filter replacement assembly of FIG. 6 in a replacement position;

FIG. 8 is a schematic view of a further exemplary alternative filter replacement assembly that may be used with the inlet air treatment system shown in FIG. 1;

FIG. 9 is a schematic view of the exemplary filter replacement assembly of FIG. 8 in a replacement position; and

FIG. 10 is a flowchart of a method of operating the inlet air treatment system shown in FIG. 1.

### DETAILED DESCRIPTION OF THE INVENTION

The exemplary methods and systems described herein overcome the disadvantages of known inlet air treatment systems by providing a coalescer replacement assembly that removes a used coalescer, i.e., a “first” coalescer, from operation without requiring manual intervention or a shutdown of the associated turbine. More specifically, the embodiments described herein facilitate replacing a used coalescer during operating periods when the pressure drop through the used coalescers is high enough, as detected by an electronic differential pressure sensor, to reduce compressor operating efficiency or to risk a compressor surge that may damage the compressor. In addition, the embodiments described herein facilitate automatically replacing the used coalescer with an unused coalescer, i.e., a “second” coalescer, without requiring a human operator to remove the used coalescer from service.

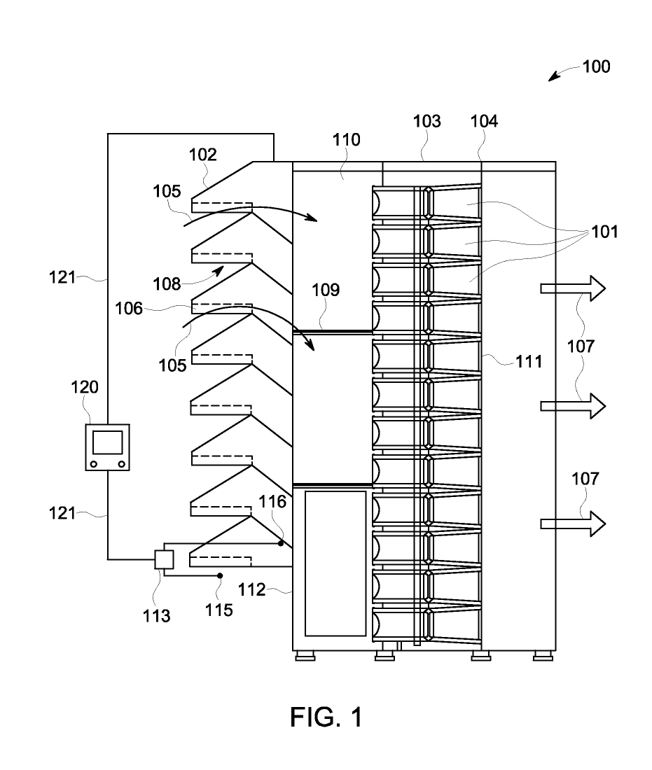

FIG. 1 is a diagram of an exemplary inlet air treatment system 100 that includes multiple intake hoods 102, internal channel 110, filters 101, tube sheet 104, and filter house 103 that receives intake airflow 105 and removes moisture and dust therefrom. Inlet air treatment system 100 then directs the filtered exit airflow 107 through downstream ducts. During operation, inlet air treatment system 100 may channel the filtered exit airflow 107 to a gas turbine, such as described above.

The operation of inlet air treatment system 100 may be monitored by several sensors that detect various conditions inside and outside of the inlet air treatment system 100. For example, electronic or mechanical pressure sensors 113 may monitor ambient air pressure outside of the intake hoods 102 at outside sensing point 115 and static pressure levels within intake hoods 102 at inside sensing point 116, thereby determining a differential pressure magnitude across a coalescer 106. The differential pressure may increase due to decreased intake airflow 115 through the coalescer which may be caused by dust, dirt, moisture, or other debris clogging air passages in the coalescer. The air passages may also be blocked with ice forming therein during low temperature operation. The pressure sensors 113 may be positioned at one or more of the intake hoods 102 at a first side of coalescers 106 to monitor air pressure of intake air 105 prior to entering coalescers 106 and at a second side of coalescers 106 after exiting coalescers 106 as just described. Pressure sensors 113 may monitor other locations in an air stream within inlet air treatment system 100.

Inlet air treatment system 100 includes intake hood assemblies 102 that are coupled in flow communication with the filter house 103, such that an intake airflow 105 is defined between an assembly of intake hoods 102 and air filters 101. Intake hoods 102 are vertically-spaced and mounted to a front wall 112 of filter house 103. In an exemplary embodiment, each inlet hood 120 includes a hood opening 108 allowing the intake airflow 105 to enter filter house 103, a coalescer 106, and a coalescer replacement assembly, as will be described below. Each coalescer 106 is positioned within hood opening 108 to facilitate moisture removal from intake airflow 105 channeled through hood opening 108 into filter house 103. Intake airflow 105 is channeled through inlet hood 102 through opening 108, and then toward air filters 101 via internal channel 110. Internal channel 110 is a space between intake hoods 102 and air filters 101, and includes walkways 109 for maintenance staff to manually access the coalescers 106. The use of coalescers 106 for removing moisture from intake airflow 105 is well known. Typical coalescers 106 include at least two interoperative layers, namely, a first layer comprising a moisture separator and, on top of that, a coalescing pad. The layered structures of the coalescers 106 are illustrated herein as a unitary structure for simplicity since the layered structure is not essential to the embodiments described herein.

In one embodiment, filter house 103 includes a tube sheet 104 upon which cartridge-type filter elements 101 are mounted. In the exemplary embodiment, a plurality of access walkways 109 extend between the matrix of filter elements 101 and the intake hoods 102 to provide access to each inlet hood 120 and the coalescers 106. The plurality of filters 101 are each coupled to tube sheet 104 such that each filter 101 extends circumferentially about a corresponding opening 111 in the tube sheet 104 to provide an exit path for exiting airflow 107. In one exemplary embodiment, filters 101 are in flow communication with ambient air entering the inlet air treatment system 100 via the intake hoods 102 and the cleaned exit airflow 107 to the right of filter system 100, as seen in FIG. 1. Similar to pulse filters (cylindrical filters) explained above, static rectangular filters can also be used which are clamped/bolted to a frame instead of a tube sheet.

During operation of inlet air treatment system 100, intake hoods 102 channel intake airflow 105 toward air filters 101. As intake airflow 105 enters intake hoods 102 through coalescers 106, the coalescers 106 act to remove moisture from the intake airflow 105. Airflow 105 travels through internal channel 110 through filters 101 which remove dust and debris carried by airflow 105. Exit airflow 107 is then channeled to a downstream gas turbine, for example. The gas turbine provides the suction for forcing the intake airflow 105 to be drawn into inlet air treatment system 100 through intake hoods 102, the coalescers 106, and through the air filters 101.

In one embodiment, a control system 120 that may be implemented in hardware and/or software communicates with pressure sensors 113 via wired or wireless communication links 121. In one embodiment, the communication links 121 comprise electric circuits remotely communicating data and command signals between the pressure sensors 113 and the control system 120 in accordance with any wired or wireless communication protocol known to one of ordinary skill in the art guided by the teachings herein. Such data signals may include electric signals indicative of differential pressure magnitudes detected by pressure sensors 113 transmitted to the control system 120 and, in response thereto, various command signals communicated by the control system 120 to inlet air treatment system 100, such as described below.

The control system 120 may be a computer system of sufficient complexity to receive data signals from pressure sensors 113 indicating a magnitude of measured differential air pressure and to perform diagnostics on those parameters such as determining whether the measured differential air pressure is within a stored preset threshold. A sufficient hardware embodiment may include a controller, a microcontroller, a microcomputer, a programmable logic controller (PLC), a field programmable gate array (FPGA), an application specific integrated circuit, and other programmable circuits. It should be understood that a processor and/or control system 120 can also include memory, input channels, and output channels. The control system 120 executes stored programs to control the operation of the inlet air treatment system 100 based on data signals received from pressure sensors 113 and on stored settings input by human operators. Programs executed by the control system 120 may include, for example, calibrating algorithms for calibrating pressure sensors 113. User input may be provided by a display which includes a user input selection device. In one embodiment the display may be responsive to user contact or the control system 120 may contain a keyboard or keypad which operates in a conventional well known manner. Thus, the user can input desired operational functions, numerical ranges, and thresholds available with the control system 120. Commands may be generated by the control system in response to parameter magnitudes received as data signals from pressure sensors 113 to activate various operations and controls on inlet air treatment system 100 as described herein. Operations performed by assemblies within filter house 103 in response to an air pressure differential exceeding a preset maximum, as detected and reported by pressure sensors 113, include automatic coalescer replacement. As mentioned above, increased differential air pressure is typically caused by blocked air passages in the coalescer due to dirt, debris, or ice formation. The control system 120 can used together with existing differential air pressure monitoring systems by receiving the output differential air pressure measurement signals therefrom.

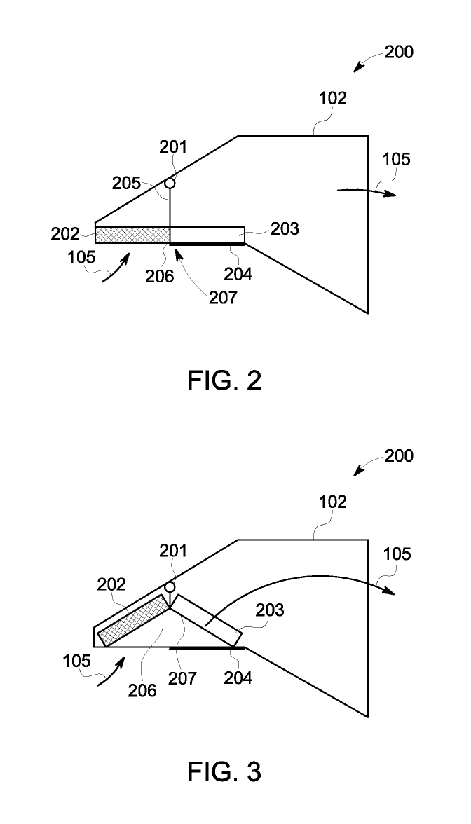

FIG. 2 and FIG. 3 are diagrams of an exemplary coalescer replacement assembly 200 disposed within an intake hood 102, and that may be used within one or more of the intake hoods 102 in the inlet air treatment system 100. In an exemplary embodiment, inlet air treatment system 100 includes a plurality of intake hoods 102 coupled to an outer wall 112 of the filter house 103. Each intake hood 102 includes a frame bracket member for supporting a used coalescer 202 in position across hood opening 108 to remove moisture from the intake airflow 105 passing therethrough, as well as backup or unused coalescer 203. A plurality of coalescers 202, 203 are disposed within hoods 102 of air inlet treatment system 100 such that a major surface of each used coalescer 202 substantially covers the air inlet path into the hood 102 provided by hood opening 108. The coalescer 202, 203 may be manufactured to include a perimeter frame that fits into the frame bracket member for suspending the coalescer 202, 203 across the entirety of the hood opening 108 when they are placed in use. In the assembly as shown in FIG. 2, used coalescer 202 is in position to substantially cover the hood opening 108, such that an airflow 105 enters through a major frontal surface of used coalescer 202 while unused coalescer 203 is positioned over a solid panel 204 that prevents intake airflow 105 from passing through unused coalescer 203. De-moistured intake airflow 105 exits used coalescer 202 through a rearward major surface of used coalescer 202 and into the filter house 103.

FIG. 3 illustrates the coalescers 202, 203 in a replacement position wherein used coalescer 202 is moved away from intake airflow 105 while unused coalescer 203 is moved into intake airflow 105, as shown. The hood opening in the replacement position may only be partially covered by unused coalescer 203, such that airflow 105 may enter the filter house 103 without flowing through at least a portion of unused coalescer 203. A plurality of filter replacement assemblies 200 are each positioned in a corresponding one of a plurality of inlet hoods 102 such that coalescers 202, 203 can be moved between operating positions as illustrated in FIG. 2 and FIG. 3. But for the accumulation of dust and other debris within used coalescer 202, the coalescers 202, 203 are similar in construction.

In one embodiment, the coalescer replacement assembly 200 includes a motorized pulley 201 attached to an inside surface of intake hood 102 for retracting or releasing cable 205 which is attached by, for example, brackets, hooks or other mechanical means, to adjacent, facing edges of coalescers 202, 203. During a retraction phase, the motorized pulley 201 draws cable 205 which pulls upward on the coalescer inside edges 206, 207, thereby retracting used coalescer 202 until it contacts an inside surface of intake hood 120 as shown in the replacement position illustrated in FIG. 3. Unused coalescer 203 is pulled away from solid panel 204 and into the intake airflow 105 and begins operating to remove moisture therefrom, as explained above in relation to the operation of used coalescer 202. The motorized pulley 201 is electrically connected to control system 120 and is activated into a retraction phase by an electric signal therefrom.

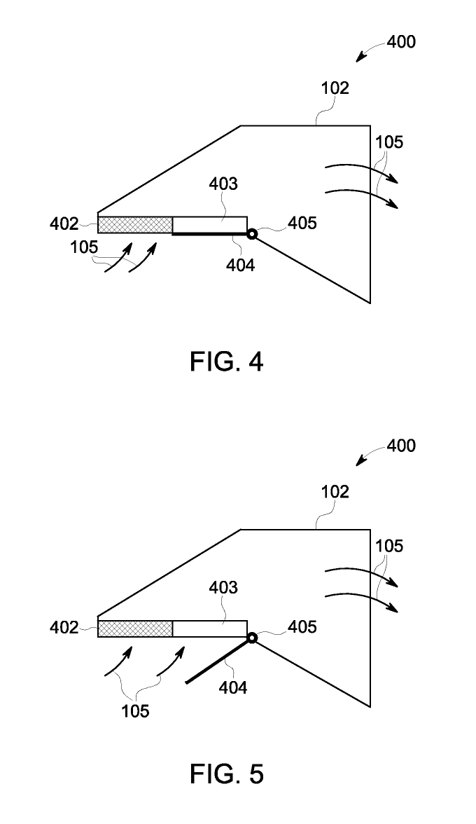

FIG. 4 and FIG. 5 are diagrams of an exemplary coalescer replacement assembly 400 disposed within an intake hood 102, and that may be used within one or more of the intake hoods 102 illustrated in the inlet air treatment system 100. In an exemplary embodiment, inlet air treatment system 100 includes a plurality of intake hoods 102 coupled to an outer wall 112 of the filter house 103. Each intake hood 102 includes a frame bracket member for supporting a used coalescer 402 in position across hood opening 108 to remove moisture from the intake airflow 105 passing therethrough, as well as backup or unused coalescer 403. A plurality of coalescers 402, 403 are disposed within hoods 102 of air inlet treatment system 100 such that a major surface of each of used coalescers 402 substantially cover the air inlet paths into the hoods 102 provided by hood openings 108. The coalescers 402, 403 may be manufactured to include a perimeter frame that fits into the frame bracket member for suspending the coalescers 402, 403 across the entirety of the hood opening 108 when they are placed in use. In the assembly as shown in FIG. 4, used coalescer 402 is in position to substantially cover the hood opening 108, such that an airflow 105 enters through a major frontal surface of used coalescer 402 while unused coalescer 403 is positioned over a solid panel 404 that prevents intake airflow 105 from passing through unused coalescer 403. De-moistured intake airflow 105 exits used coalescer 402 through a rearward major surface of used coalescer 402 and into the filter house 103.

FIG. 5 illustrates the coalescers 402, 403 in a replacement position wherein panel 404 is rotated downward and away from unused coalescer 403 such that unused coalescer is no longer blocked by panel 404 and intake airflow passes through unused coalescer 403. A plurality of filter replacement assemblies 400 are each positioned in a corresponding one of a plurality of inlet hoods 102 such that panel 404 can be moved between operating positions as illustrated in FIG. 4 and FIG. 5. But for the accumulation of dust and other debris within used coalescer 402, the coalescers 402, 403 are similar in construction.

In one embodiment, the coalescer replacement assembly 400 includes a motorized hinge 405 attached to intake hood 102 for rotating panel 404 which is attached to the motorized hinge by, for example, a brackets or it may be formed integrally with motorized hinge 405. During a rotation phase, the motorized hinge 405 rotates the panel downward away from unused coalescer 403 until it reaches the position as shown in FIG. 5. Unused coalescer 403 is thus positioned within intake airflow 105 and begins operating to remove moisture therefrom, as explained above in relation to the operation of used coalescer 402. The motorized hinge 405 is electrically connected to control system 120 and is activated into a downward rotation phase by an electric signal therefrom.

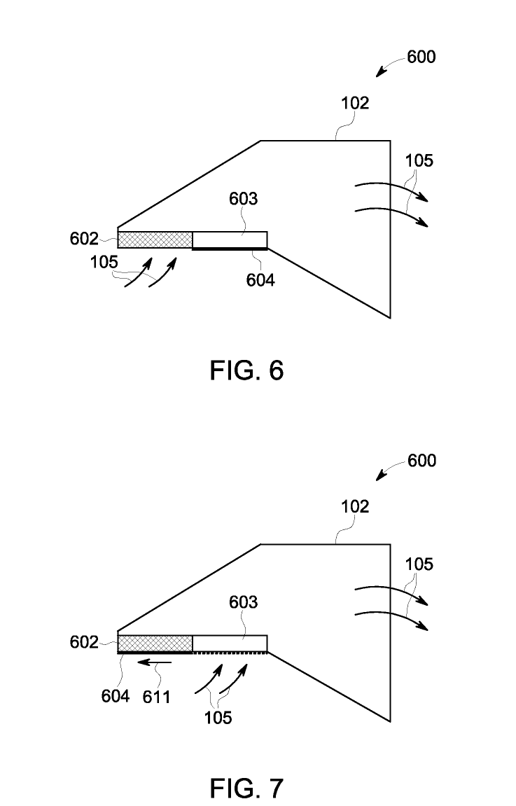

FIG. 6 and FIG. 7 are diagrams of an exemplary coalescer replacement assembly 600 disposed within an intake hood 102, and that may be used within one or more of the intake hoods 102 illustrated in the inlet air treatment system 100. In an exemplary embodiment, inlet air treatment system 100 includes a plurality of intake hoods 102 coupled to an outer wall 112 of the filter house 103. Each intake hood 102 includes a frame bracket member for supporting a used coalescer 602 in position across hood opening 108 to remove moisture from the intake airflow 105 passing therethrough, as well as backup or unused coalescer 603. A plurality of coalescers 602, 603 are disposed within hoods 102 of air inlet treatment system 100 such that a major surface of each of used coalescers 602 substantially cover the air inlet paths into the hoods 102 provided by hood openings 108. The coalescers 602, 603 may be manufactured to include a perimeter frame that fits into the frame bracket member for suspending the coalescers 602, 603 across the entirety of the hood opening 108 when they are placed in use. In the assembly as shown in FIG. 6, used coalescer 602 is in position to substantially cover the hood opening 108, such that an airflow 105 enters through a major frontal surface of used coalescer 602 while unused coalescer 603 is positioned over a movable solid panel 604 that prevents intake airflow 105 from passing through unused coalescer 603. De-moistured intake airflow 105 exits used coalescer 602 through a rearward major surface of used coalescer 602 and into the filter house 103.

FIG. 7 illustrates the coalescers 602, 603 in a replacement position wherein movable panel 604 is moved in direction 611 into a position under used coalescer 602 and away from unused coalescer 603, thereby blocking intake airflow 105 from passing through used coalescer 602 while allowing intake airflow 105 to pass through unused coalescer 603. A plurality of filter replacement assemblies 600 are each positioned in a corresponding one of a plurality of inlet hoods 102 such that coalescers 602, 603 can be moved between operating positions as illustrated in FIG. 6 and FIG. 7. But for the accumulation of dust and other debris within used coalescer 602, the coalescers 602, 603 are similar in construction.

In one embodiment, the coalescer replacement assembly 600 includes a movable panel 604 that slides or rolls along a track attached to intake hood 102. During a movement phase, a motor driven shaft or cable attached to movable panel 604 slides or rolls the panel until it contacts an inside edge of intake hood 120 as shown in the replacement position illustrated in FIG. 7. Unused coalescer 603 is thereby placed into the intake airflow 105 and begins operating to remove moisture therefrom, as explained above in relation to the operation of used coalescer 602. The motor driving movable panel 604 is electrically connected to control system 120 and is activated by an electric signal therefrom.

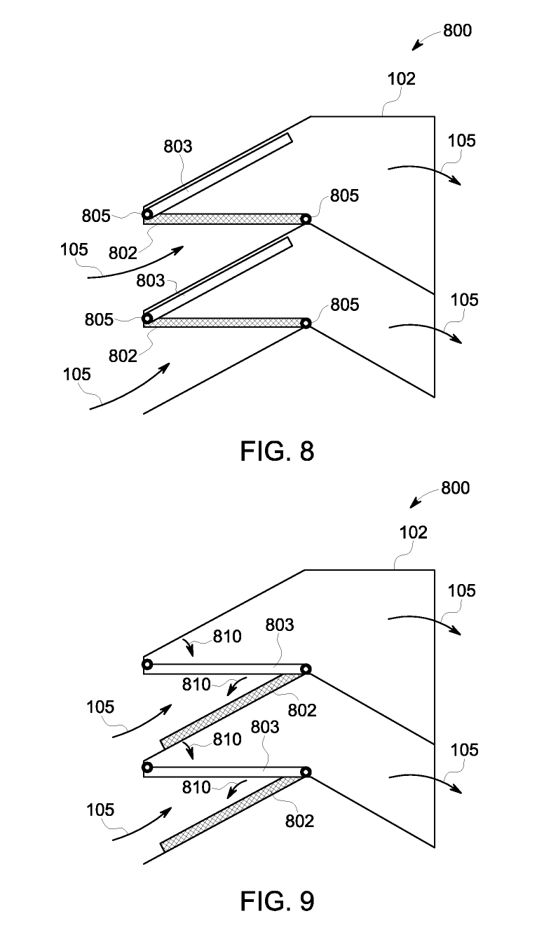

FIG. 8 and FIG. 9 are diagrams of an exemplary coalescer replacement assembly 800 disposed within an intake hood 102, and that may be used within one or more of the intake hoods 102 illustrated in the inlet air treatment system 100. In an exemplary embodiment, inlet air treatment system 100 includes a plurality of intake hoods 102 coupled to an outer wall 112 of the filter house 103. Each intake hood 102 includes a retractable bracket or pin for securing one end of coalescers 802, 803, while the other end of coalescers 802, 803, are attached to hinge 805, thereby supporting the used coalescers 802 in position across hood opening 108 to remove moisture from the intake airflow 105 passing therethrough. Similarly, retractable pins or brackets are used for securing backup or unused coalescers 803 against an inside surface of intake hood 102 out of the path of intake airflow 105. A plurality of coalescers 802, 803, are disposed within hoods 102 of air inlet treatment system 100 such that a major surface of each of used coalescers 802 substantially cover the air inlet paths into the hoods 102 provided by hood openings 108. In the assembly as shown in FIG. 8, used coalescers 802 are in position to substantially cover the hood openings 108, such that an airflow 105 enters through a major frontal surface of used coalescers 802 while unused coalescers 803 are each positioned against an inside surface of intake hood 102 which prevents intake airflow 105 from passing through unused coalescers 803. De-moistured intake airflow 105 exits used coalescers 802 through a rearward major surface of used coalescers 802 and into the filter house 103.

FIG. 9 illustrates the coalescers 802, 803 in a replacement position wherein used coalescers 802 are rotated in direction 810 downward away from intake airflow 105 and against an exterior surface of an intake hood 102 below it, while unused coalescers 803 are also rotated in direction 810 downward, into the positions evacuated by used coalescers 802 and into the intake airflow 105. A plurality of filter replacement assemblies 800 are each positioned in a corresponding one of a plurality of inlet hoods 102 such that coalescers 802, 803 can be moved into positions as illustrated in FIG. 8 and FIG. 9. But for the accumulation of dust and other debris within used coalescer 802, the coalescers 802, 803 are similar in construction.

In one embodiment, the coalescer replacement assembly 800 includes a hinge attached to one end of each coalescer 802, 803 while retractable pins or brackets are attached to an opposite end of each coalescer 802, 803, thereby securing each of coalescers 802, 803 in position as shown. The retractable pins or brackets may be spring biased to support the coalescers 802, 803 in position and, once retracted, such as by an electric motor connected thereto, allow the coalescers 802, 803 to rotate in direction 810 downward due to the force of gravity. The hinges at the opposite ends of used coalescers 802 allow the used coalescers 802 to rotate in direction 810 downward and against an exterior surface of the intake hood 102 below it, and the unused coalescers 803 rotate in direction 810 downward until they contact the retractable pins or brackets, previously supporting used coalescers 802, for support. During a rotation phase of the used coalescers 802, the retractable pins or brackets are retracted to allow the used coalescers 802 to rotate downward. These retractable pins or brackets return to their original position and the retractable pins or brackets holding unused coalescers 803 in place are thereafter retracted which allows the unused coalescers 803 to similarly rotate downward until they contact the retractable pins or brackets for securing unused coalescer 803 in position across hood opening 108 and begins operating to remove moisture from intake airflow 105.

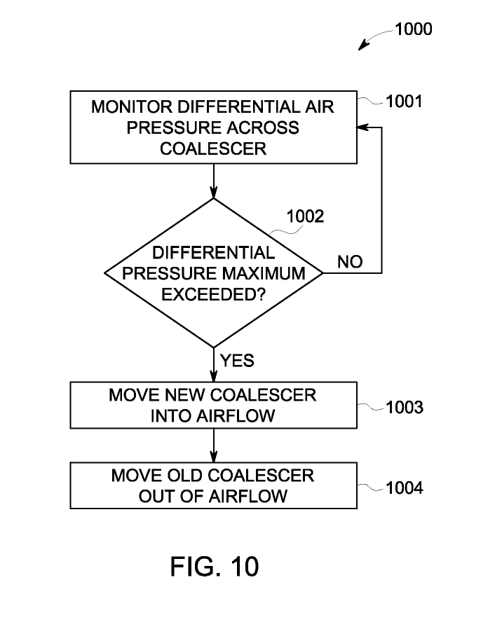

With reference to FIG. 10, there is illustrated a method 1000 of operating an inlet air treatment system 100 as described above. In a first step, step 1001, air pressure sensor 113 monitors at least two air pressures of intake air 105. One position that is monitored is an air flow 105 just prior 115 to entering intake hood 102 and a second position that is monitored is air flow 105 just after 116 passing through used coalescer 202, 402, 602, 802. If the monitored air pressure differential exceeds a programmed maximum as determined at step 1002 then, at step 1003, the control system 120 transmits a command signal to activate a mechanism, such as an electric motor, that causes an unused backup coalescer 203, 403, 603, 803, to be positioned into the intake airflow 105. This may be performed by activating a motor that moves the unused coalescer 203, 403, 603, 803, into position in the intake airflow 105 or it may move a panel to unblock the intake airflow 105 from the unused coalescer 203, 403, 603, 803, and, at step 1004, it may also include moving the panel to block an intake airflow 105 from used coalescer 202, 402, 602, 802, or moving the used coalescer 202, 402, 602, 802, out of the intake airflow 105.

In view of the foregoing, embodiments of the invention improve efficiency of gas turbines by avoiding downtime caused by manual interventions to replace coalescers. A technical effect is the automatic detection of excessive differential air pressure which indicates that replacement of coalescers is necessary, and an automated response to carry out the replacement. The above-described systems and methods facilitate replacing an intake air coalescer without requiring a shutdown of the associated turbine engine. As such, the cost of maintaining the gas turbine is reduced.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,”, “module,” “processor”, “controller” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An inlet air treatment system comprising:
a first coalescer having an airflow passing therethrough;
a second coalescer blocked by a plate from having the airflow passing therethrough; and
a motorized mechanism attached to the plate for moving the plate and unblocking the second coalescer causing the airflow to pass through the second coalescer.

2. The inlet air treatment system of claim 1, further comprising a differential pressure sensor for detecting an air pressure at a first side of the first coalescer and an air pressure at a second side of the first coalescer.

3. The inlet air treatment system of claim 2, further comprising an electric switch electrically connected to the differential pressure sensor for activating the motorized mechanism in response to the differential pressure sensor detecting a pressure differential above a preset threshold.

4. The inlet air treatment system of claim 1, wherein the motorized mechanism attached to the plate for moving the plate causes the plate to move parallel to a major surface of the first coalescer and blocks the first coalescer to prevent the air from passing through the first coalescer.

5. The inlet air treatment system of claim 1, wherein the motorized mechanism is a hinge mechanism that rotates the plate away from the second coalescer.

6. An inlet air treatment system comprising:
first coalescer having intake air passing therethrough;
a second coalescer blocked from having the intake air passing therethrough; and
a lifting mechanism attached to facing edges of the first and the second coalescers for lifting the facing edges of the first and the second coalescers such that the first coalescer is moved away from an intake air pathway while the second coalescer is moved into the intake air pathway.

7. The inlet air treatment system of claim 6, further comprising a differential pressure sensor for detecting an air pressure at a first side of the first coalescer and an air pressure at a second side of the first coalescer.

8. The inlet air treatment system of claim 7, further comprising an electric circuit connected to the lifting mechanism and to the differential pressure sensor for activating the lifting mechanism in response to the differential pressure sensor detecting a pressure differential above a preset threshold.

9. The inlet air treatment system of claim 6, wherein the lifting mechanism comprises a cable attached at one end to the facing edges of the first and the second coalescers and attached at another end to a motorized pulley for retracting the cable.

10. An inlet air treatment system comprising:
a first coalescer positioned in an intake air pathway and having intake air passing therethrough;
a second coalescer positioned away from the intake air pathway;
the first coalescer attached to a first mechanism for moving the first coalescer out of the air intake pathway to prevent the intake air from passing therethrough; and
the second coalescer attached to a second mechanism for moving the second coalescer into the air intake pathway and causing the intake air to pass therethrough.

11. The inlet air treatment system of claim 10, further comprising a differential pressure sensor for detecting an air pressure at a first side of the first coalescer and an air pressure at a second side of the first coalescer.

12. The inlet air treatment system of claim 11, further comprising an electric switch connected to the differential pressure sensor for activating the first and second mechanisms and causing said moving the first coalescer out of the air intake pathway and said moving the second coalescer into the air intake pathway.

13. The inlet air treatment system of claim 12, wherein the first and second mechanisms each include a hinge and a retractable bracket or pin.

14. The inlet air treatment system of claim 13, wherein the first mechanism causes the first coalescer to rotate away from the air intake pathway.

15. The inlet air treatment system of claim 14, wherein the second mechanism causes the second coalescer to rotate from a position against an inside surface of an intake hood into the air intake pathway.

16. A method comprising:
electronically monitoring a differential pressure across a first coalescer having a forced airflow passing therethrough;
electronically detecting that the differential pressure exceeds a preset stored threshold; and
mechanically introducing a second coalescer into the forced airflow in response to the step of electronically detecting.

17. The method of claim 16, further comprising mechanically removing the first coalescer from the forced airflow in response to the step of electronically detecting.

18. The method of claim 17, wherein the step of mechanically removing the first coalescer comprises rotating the first coalescer about a hinge connected to one end of the first coalescer and wherein the step of mechanically introducing the second coalescer comprises rotating the second coalescer about a hinge connected to one end of the second coalescer.

19. The method of claim 17, wherein the step of mechanically removing the first coalescer comprises moving a panel to a position in front of the first coalescer to block the forced airflow from the first coalescer and wherein the step of mechanically introducing the second coalescer comprises moving the panel away from a position in front of the second coalescer to unblock the forced airflow from the second coalescer.

20. The method of claim 17, wherein the step of mechanically removing the first coalescer and the step of mechanically introducing the second coalescer both comprise the step of lifting facing edges of the first and the second coalescers.
